(19) United States
(12) Patent Application Publication
(10) Pub. No.: US 2015/0214817 A1
(43) Pub. Date: Jul. 30, 2015

(54) MOTOR HAVING COOLING FUNCTION

(71) Applicant: HYUNDAI MOBIS CO., LTD., Seoul (KR)

(72) Inventor: Sang-Jin Kim, Yongin-si (KR)

(21) Appl. No.: 14/599,255

(22) Filed: Jan. 16, 2015

(30) Foreign Application Priority Data
Jan. 28, 2014 (KR) 10-2014-0010128

(51) Int. Cl. H02K 9/193

(52) U.S. Cl. CPC H02K 9/193

(57) ABSTRACT

One aspect of the invention provides a motor comprising a housing; a rotating shaft disposed in the housing and supported by the housing; a stator disposed in the housing; a rotor configured to rotate with respect to the stator and integrally fastened with a rotating shaft; and an impeller mounted over an outer wall of the rotating shaft and comprising at least one wing, wherein the rotating shaft is formed of a hollow shaft so as to contain oil therein, the rotating shaft comprising at least a through hole radially extending toward the impeller such that the oil contained in the rotating shaft can be discharged through the through hole and scattered by the at least one wing.

### CROSS-REFERENCE(S) TO RELATED APPLICATIONS

This application claims priority to Korean Patent Application No. 10-2014-0010128, filed on Jan. 28, 2014, which is incorporated herein by reference in its entirety.

### BACKGROUND

1. Field

Embodiments of the present invention relate to a motor, and more particularly, to a motor having a cooling function capable of cooling a heated portion of the motor by making oil charged in the motor circulate the motor at the time of driving the motor.

2. Description of Related Art

A motor which generates a torque when being supplied with electric power has various structures. When operating the motor, heats are generated in various parts of the motor. Such heats would limit the power of the motor and/or deteriorate the parts of the motor. Thus, various configurations for cooling the various portions of the motor are proposed.

### SUMMARY

One aspect of the invention provides a motor comprising a housing; a rotating shaft disposed in the housing and supported by the housing; a stator disposed in the housing; a rotor configured to rotate with respect to the stator and integrally fastened with a rotating shaft; and an impeller mounted over an outer wall of the rotating shaft and comprising at least one wing, wherein the rotating shaft is formed of a hollow shaft so as to contain oil therein, the rotating shaft comprising at least a through hole radially extending toward the impeller such that the oil contained in the rotating shaft can be discharged through the through hole and scattered by the at least one wing.

An embodiment of the present invention is directed to a motor having a cooling function capable of radiating heat generated at the time of driving the motor, by automatically circulating oil charged therein by rotating a rotating shaft without a separate component for circulating the oil.

Other features and advantages of the present invention can be understood by the following description, and become apparent with reference to the embodiments of the present invention. Also, it is obvious to those skilled in the art to which the present invention pertains that the features and advantages of the present invention can be realized by the means as claimed and combinations thereof.

In accordance with an embodiment of the present invention, there is provided a motor having a cooling function in which a rotor integrally fastened with a rotating shaft inside a stator is installed inside a housing, wherein the rotating shaft is formed of a hollow shaft to charge oil therein and is provided with a through hole which radially penetrates through the rotating shaft and an outer side of a portion at which the rotating shaft is provided with the through hole is coupled with an impeller which discharges the oil discharged from the through hole in a radius direction of the rotating shaft.

The rotating shaft may have a portion adjacent to an end thereof provided with the through hole.

The through hole may be formed along a circumference of the rotating shaft at a predetermined interval.

The impeller may be coupled with the rotating shaft so as to position the through hole between two adjacent wings of the impeller.

The number of through holes which is formed at the rotating shaft may be equal to the number of wings of the impeller.

A gap may be formed between an outer side of the impeller and an inner side of the housing to circulate the oil.

The housing may be provided with an oil passage through which the oil discharged from the impeller is again introduced into the rotating shaft.

In the housing, a portion at which the impeller is installed may be provided with a bearing supporting the rotating shaft.

The bearing may have one side exposed to the oil passage.

A middle of the oil passage may be provided with an oil tank in which the oil is stored.

The housing may be provided with a cooling water channel through which cooling water is circulated and the oil passage may be provided at an outer side of the cooling water channel.

### BRIEF DESCRIPTION OF THE DRAWINGS

FIG. 1 is a cross-sectional view illustrating a motor.

FIG. 2 is a perspective view illustrating a rotor, a rotating shaft, and a bearing in the motor shown in FIG. 1.

FIG. 3 is a cross-sectional view illustrating a motor having a cooling function in accordance with an embodiment of the present invention.

FIG. 4 is a cross-sectional view taken along the line A-A of FIG. 3.

FIG. 5 is a perspective view illustrating a rotating shaft and an impeller in the motor having a cooling function in accordance with an embodiment of the present invention.

FIG. 6 is a perspective view illustrating the rotating shaft and the impeller in the motor having a cooling function in accordance with an embodiment of the present invention.

### DESCRIPTION OF EMBODIMENTS

Hereinafter, a motor having a cooling function in accordance with embodiments of the present invention will be described with reference to the accompanying drawings.

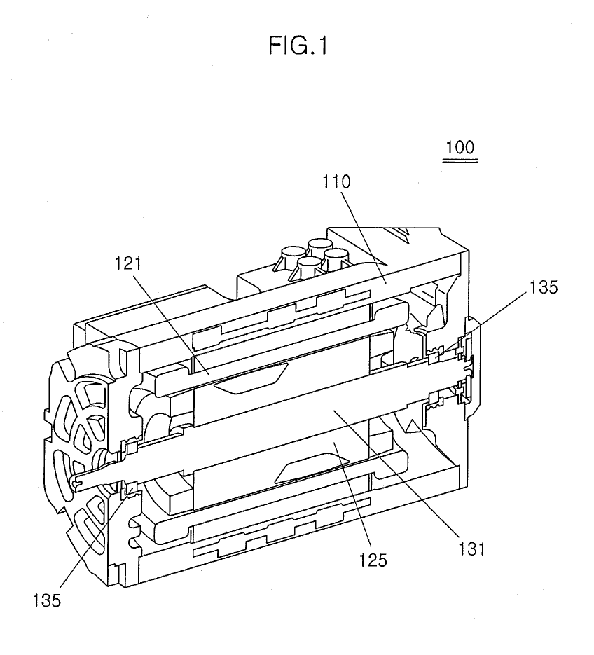

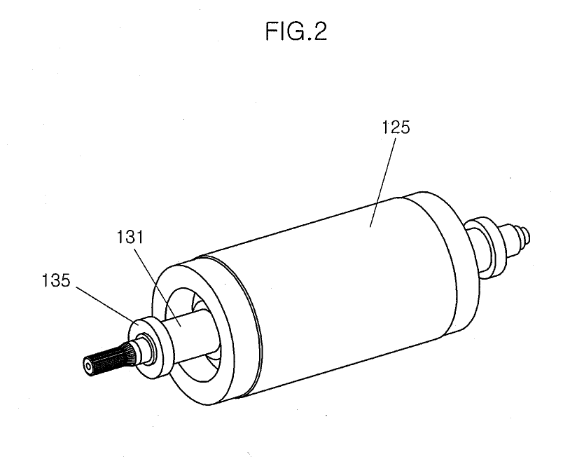

In an example illustrated in FIGS. 1 and 2, an induction motor 100 includes a rotor 125 which is integrally fastened with a rotating shaft 131 inside a stator 121. In this configuration, when a current is applied to a stator coil installed in the stator 121, an induction current is generated in the rotor 125 to rotate the rotor 125, thereby generating a torque.

In the induction motor 100, the rotor 125 may generate higher heat than other parts, due to the induction current generated in the rotor 125. In addition, the rotor 125 generates high heat, and therefore as a bearing 135 supporting the rotating shaft 131, a bearing of a general specification is not applied, but a bearing of a special specification which may withstand against high heat is applied, such that motor cost may be increased.

Meanwhile, to radiate heat generated from the motor 100, a technology that the motor has a pump and an oil tank provided therein and when the motor 100 rotates, the pump connected to the rotating shaft 131 of the motor 100 is driven to circulate oil stored in an oil tank has been proposed.

However, as described above, when the oil for cooling is forcibly circulated by the pump, a size of the motor 100 may be increased and manufacturing cost may be increased.

Further, since the bearing 135 supporting the rotating shaft 131 of the motor 100 may not be lubricated, the bearing of a special specification which may be used at high heat needs to be applied.

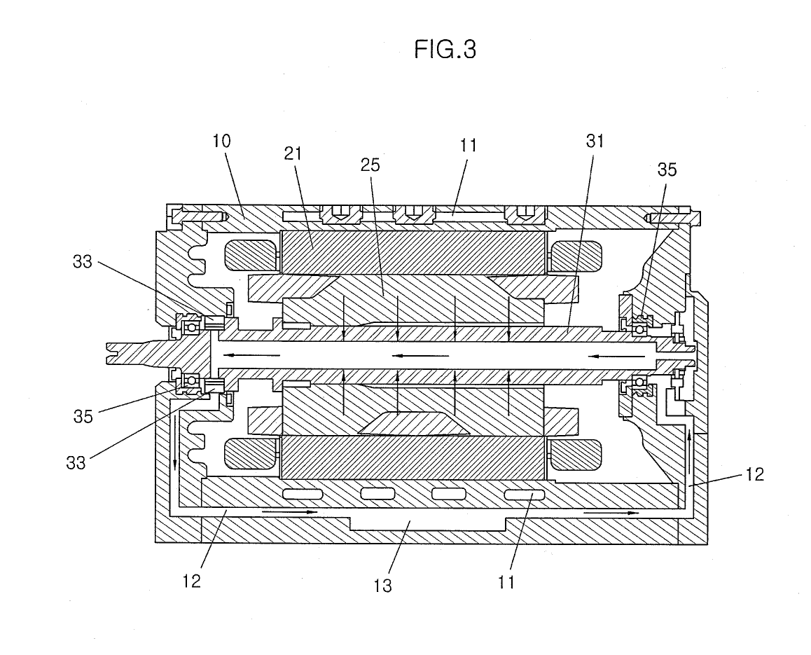

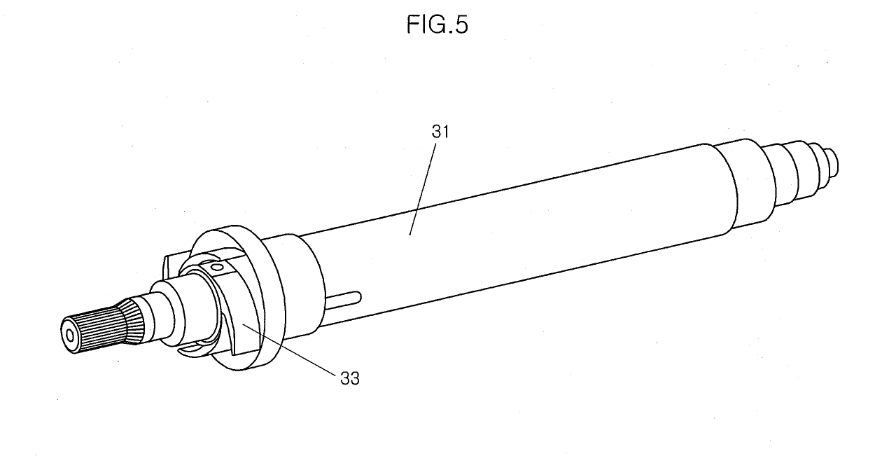

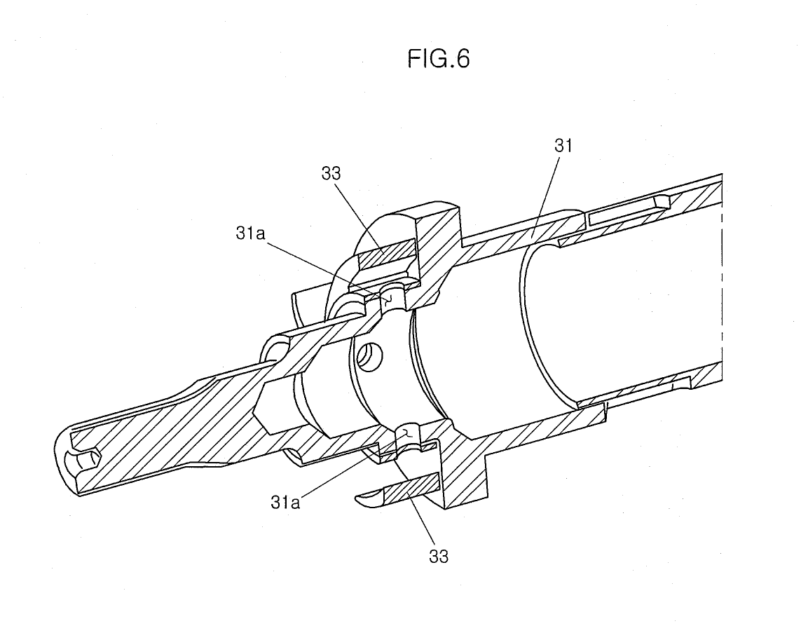

Referring to FIGS. 3-6, in a motor having a cooling function in accordance with an embodiment of the present invention in which a rotor 25 which is integrally fastened with a rotating shaft 31 inside a stator 21 is installed inside a housing 10, the rotating shaft 31 is formed of a hollow shaft to charge oil therein and is provided with a through hole 31a which radially penetrates through the rotating shaft 31 and an outer side of a portion at which the rotating shaft 31 is provided with the through hole 31a is coupled with the impeller 33 which radially discharges the oil discharged from the through hole 31a.

The housing 10 forms an appearance of the motor 1 and has a stator 21, a rotor 25, a rotating shaft 31, and the like, provided therein.

The housing 10 may be provided with a cooling water channel 11 through which cooling water supplied from the outside is circulated to cool heat generated from the motor 1.

The stator 21 is fixedly installed inside the housing 10. The stator 210 is present in a state in which a coil is wound around the stator 10, and therefore, when the stator 21 is applied with electric power, the coil is magnetized and thus the motor 1 outputs a torque.

The rotor 25 is rotatably installed inside the stator 21. The rotor is formed in an aluminum ingot form and when the coil of the stator 21 is magnetized, an induction current is generated in the rotor 25 and thus the rotor 25 rotates about the stator 21.

The rotating shaft 31 is integrally formed with the rotor 25 at a rotating center of the rotor 25. The rotating shaft 31 has a hollow shaft form in which an inside is hollow and the inside of the rotating shaft 31 is charged with oil.

Further, one side of the rotating shaft 31 is provided with the through hole 31a which penetrates through the inside and an outside of the rotating shaft 31. The through holes 31a are formed along a circumference of the rotating shaft 31 at a predetermined interval and the oil charged in the rotating shaft 31 through the through hole 31a is discharged to the outside of the rotating shaft 31.

In particular, the through hole 31a of the rotating shaft 31 is distant from the middle of the rotating shaft 31 so as to be formed at a portion adjacent to one end thereof, such that in the inside of the rotating shaft 31, oil flows in a direction from a portion where the through hole 31a is not formed to a portion where the through hole 31a is formed (direction from right to left in FIG. 3).

The impeller 33 is coupled with an outer side of the portion where the through hole 31a is formed at the rotating shaft 31. The impeller 33 is provided with wings along the circumference of the rotating shaft 31 at the same interval. As the impeller 33 rotates, the wings serve to discharge a fluid positioned at a center of the impeller 33 to the outside.

When the impeller 33 is coupled with the rotating shaft 31, the impeller 33 is coupled with the rotating shaft 31 so that the through holes 31a are positioned between adjacent wings.

Further, the number of through holes 31a which are formed at the rotating shaft 31 may be equal to the number of wings of the impeller 33.

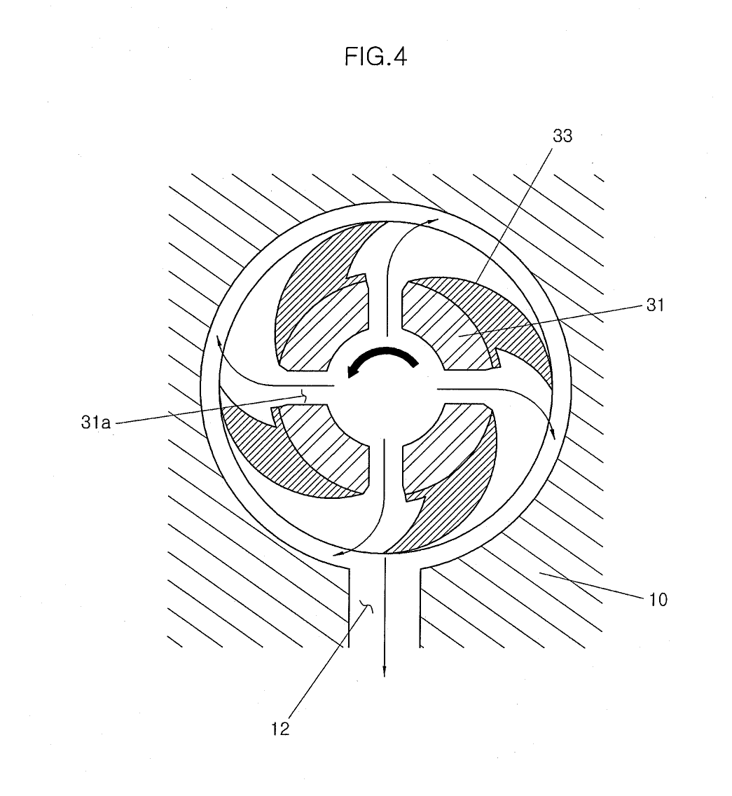

As illustrated in FIG. 4, when the rotating shaft 31 is provided with four through holes 31a at an interval of 90°, the impeller 33 is also provided with four wings and the through hole 31a is positioned between adjacent wings.

Further, a gap is formed between an outer circumference of the impeller 33 and an inner side of the housing 10 and thus the oil discharged from the impeller 33 may flow along the gap.

Therefore, the oil discharged from the rotating shaft 31 through the through hole 31a is discharged to the outside by the impeller 33.

An oil passage 12 is formed in the housing 10 and thus forms a passage through which the oil discharged from one end of the rotating shaft 31 is introduced into the other end of the rotating shaft 31. The oil passage 12 radiates heat absorbed from the rotor 25 and the rotating shaft 31 to the outside while the oil discharged from the rotating shaft 31 flows along the housing 10.

Meanwhile, a bearing 35 is installed in the housing 10 to support the rotating shaft 31 and one side of the bearing 35 is installed in the housing 10 to be exposed to the oil passage 12.

A middle of the oil passage 12 is provided with the oil tank 13 in which the oil is stored.

Further, the oil passage 12 is positioned outside the cooling water channel 11 in the housing 10.

An action of the motor having a cooling function in accordance with the embodiment of the present invention having the above configuration will be described below.

When electric power is applied to the motor 1, a torque is output from the motor 1 while the rotor 25 and rotating shaft 31 rotate about the stator 21.

When the rotating shaft 31 rotates, the oil positioned inside the rotating shaft 31 is discharged to the outer side of the impeller 33 while the impeller 33 fastened with the rotating shaft 31 rotates together. When the impeller 33 rotates, a pressure of a rotating center of the impeller 33 and the rotating shaft 31 is lowered and thus a negative pressure is generated, and a positive pressure is generated at the impeller 33 and therefore as illustrated in FIG. 4, the oil is discharged to the outer side of the impeller 33 along the wings of the impeller 33 from the center of the rotating shaft 31 through the through hole 31a.

Meanwhile, since the impeller 33 is fastened with a portion adjacent to one end of the rotating shaft 31, the oil flows in a direction from the other end to one end in the rotation shaft 31 and the oil is circulated inside the motor while the oil discharged from the impeller 33 is again introduced into the other end of the rotating shaft 31 through the oil passage 12.

As described above, the rotor 25 and the rotator 31 are cooled while the oil circulates the inside of the motor 1. When heat is generated by the driving of the motor 1, the oil is automatically circulated only by the driving of the motor without forcibly circulating the oil, thereby cooling the rotor 25 and the rotating shaft 31. The oil is circulated by a process of making the oil flow inside the rotating shaft 31, discharging the oil through the through hole 31a which is formed at one end of the rotating shaft 31, and introducing the oil into the other end of the rotating shaft 31 through the oil passage 12. In the process of making the oil flowing inside the rotating shaft 31, the oil absorbs the heat generated from the rotor 25 and the rotating shaft 31. Meanwhile, the oil is cooled by radiating heat through the housing 10 while the oil flows through the oil passage 12 formed in the housing 10. The oil cooled as described above is again introduced into the rotating shaft 31 and thus absorbs the heat generated from the rotor 25 and the rotating shaft 31. As the foregoing process is repeated, the center portion of the motor 1, that is, the rotor 25 and the rotating shaft 31 may be cooled.

Further, the bearing 35 supporting the rotating shaft 31 has one side exposed on the oil passage 12 and therefore the oil circulating the oil passage 12 is supplied to the bearing 35, thereby cooling the bearing 35 and lubricating the bearing 35.

The heat generated from the stator 21 is cooled by cooling water which flows in the cooling water channel 11 which is formed in a circumferential direction of the housing 10.

As described above, the oil is automatically circulated by the driving of the motor 1 without forcibly circulating the oil charged in the rotating shaft 31 to cool the rotor 25 and the rotating shaft 31, thereby improving the efficiency of the motor.

Further, the component for forcibly circulating the oil is not required and as the bearing 35 supporting the rotating shaft 31, the bearing of a general specification, not the high-temperature bearing may be applied, thereby reducing the manufacturing cost of the motor.

Since a motor having a cooling function in accordance with the embodiments of the present invention has the above configuration, it is possible to emit the heat generated from the rotor and the rotating shaft of the motor to the outside, by making the oil charged in the rotating shaft be automatically circulated inside the motor when the motor starts to drive.

Further, the separate component for forcibly circulating the oil within the motor is not required, thereby reducing the number of parts configuring the motor and the size of the motor.

Further, the oil is supplied to the bearing supporting the rotating shaft while the oil is circulated, thereby lubricating the bearing.

Further, since the temperature of the rotating shaft is reduced due to the circulation of oil, as the bearing for supporting the rotating shaft, the bearing of a general specification, not the high-temperature bearing, may be used, thereby reducing the manufacturing cost of the motor.

The foregoing embodiments are only examples to allow a person having ordinary skill in the art to which the present invention pertains to easily practice the present invention. Accordingly, the present invention is not limited to the foregoing embodiments and the accompanying drawings, and therefore, a scope of the present invention is not limited to the foregoing embodiments. Accordingly, it will be apparent to those skilled in the art that substitutions, modifications and variations can be made without departing from the spirit and scope of the invention as defined by the appended claims and can also belong to the scope of the present invention.

What is claimed is:

1. A motor comprising:
a housing;
a rotating shaft disposed in the housing and supported by the housing;
a stator disposed in the housing;
a rotor configured to rotate with respect to the stator and integrally fastened with a rotating shaft; and
an impeller mounted over an outer wall of the rotating shaft and comprising at least one wing,
wherein the rotating shaft is formed of a hollow shaft so as to contain oil therein, the rotating shaft comprising at least a through hole radially extending toward the impeller such that the oil contained in the rotating shaft can be discharged through the through hole and scattered by the at least one wing.

2. The motor of claim 1, wherein the rotating shaft has a portion adjacent to an end thereof provided with the through hole.

3. The motor of claim 1, wherein the at least a through hole comprises a plurality of through holes formed along a circumference of the rotating shaft at a predetermined interval.

4. The motor of claim 1, wherein the at least one wing comprises a plurality of wings, wherein the impeller is coupled with the rotating shaft so as to position the through hole between two adjacent wings of the impeller.

5. The motor of claim 4, wherein the at least a through hole comprises a plurality of through holes, wherein the number of through holes is equal to the number of wings of the impeller.

6. The motor of claim 1, wherein a gap is formed between an outer side of the impeller and an inner side of the housing to circulate the oil.

7. The motor of claim 1, wherein the housing is provided with an oil passage through which the oil discharged from the shaft is again introduced into the rotating shaft.

8. The motor of claim 7, further comprising a bearing supporting the rotating shaft and disposed adjacent the impeller.

9. The motor of claim 8, wherein the bearing has one side exposed to the oil passage.

10. The motor of claim 7, wherein the oil passage is provided with an oil tank in which the oil is stored.

11. The motor of claim 7, wherein the housing is provided with a cooling water channel through which cooling water is circulated, and the cooling water channel comprises at least one portion adjacent to the oil tank such that the cooling water and the oil exchange heat.
